(19) United States
(12) Patent Application Publication
(10) Pub. No.: US 2015/0178645 A1
(43) Pub. Date: Jun. 25, 2015

(54) DISCOVERING A BUSINESS RELATIONSHIP NETWORK, AND ASSESSING A RELEVANCE OF A RELATIONSHIP

(71) Applicant: THE DUN & BRADSTREET CORPORATION, Short Hills, NJ (US)

(72) Inventors: Xin YUAN, Basking Ridge (CN); Yan LIN, New Providence, NJ (US); Paul Douglas BALLEW, Madison, NJ (US); Nipa BASU, Bridgewater, NJ (US); Anjali REDDI, Martinsville, NJ (US); Robin Fry DAVIES, Macungie, PA (US); Alla KRAMSKAIA, Edison, NJ (US); Brian Scott CRIGLER, Westfield, NJ (US); Guang YANG, Short Hills (CN)

(21) Appl. No.: 14/452,946

(22) Filed: Aug. 6, 2014

Related U.S. Application Data
(60) Provisional application No. 61/919,088, filed on Dec. 20, 2013.

(51) Int. Cl. G06Q 10/06

(52) U.S. Cl. CPC G06Q 10/0635

(57) ABSTRACT

There is provided a method that includes (a) examining records that describe transactions between entities, (b) constructing, in a database, a data structure that represents a relationship network, based on the transactions, where the relationship network represents (i) a first entity and (ii) a second entity that is separated from the first entity by N tiers, and where N is a whole number greater than or equal to 1, and (c) calculating a relevance of the second entity to the first entity as a function of, i.e., based on, a characteristic of the second entity. There is also provided a system that performs the method, and a storage medium that contains instructions for controlling a processor to perform the method.

### CROSS-REFERENCE TO RELATED APPLICATIONS

The present application is claiming priority to U.S. Provisional Patent Application No. 61/919,088, filed Dec. 20, 2013, the content of which is herein incorporated by reference.

### BACKGROUND OF THE DISCLOSURE

1. Field of the Disclosure

The present document discloses a technique for discovering a business relationship network that includes a path from a first entity to a second entity, and assessing a relevance of the second entity to the first entity. The relevance can be indicative of either a risk to the first entity, or an opportunity for the first entity. In an exemplary embodiment, the technique provides for assessing a business risk for an entity, where a relevance assessment process considers a risk of the entity itself and risks of other entities in its network.

2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

Conventional techniques for credit worthiness or a credit score, such as a Fair Isaac Corporation (FICO) Credit Score, indicate a likelihood for a company to pay its current debt. Lenders, such as banks and credit card companies, use credit scores to evaluate potential risk posed by lending money to consumers. Widespread use of credit scores has made credit more widely available and cheaper for consumers.

FICO and other similar techniques analyze a company's financial history to generate a credit score. For example, FICO analyzes the company's payment history, credit utilization, length of credit history, types of credit used (e.g., installment, revolving, consumer finance and mortgage), recent searches for credit, and special factors such as liens. However, the FICO evaluation only analyzes a single company's financial history to generate a credit score. This limits the scope of the FICO evaluation and, further, fails to recognize and account for factors relating to a global supply chain.

The traditional approach of assessment of risk or opportunity of an entity is based on only information acquired about the entity itself, regardless of other entities with which it is associated, and regardless of risks and opportunities associated with the other entities. However no entity operates in a vacuum. It is associated with its suppliers and customers, and their suppliers and customers are associated with other entities as suppliers and customers. Thus, a business could be adversely impacted by a condition of its suppliers and customers. As such, risk may be considered not only in the context of credit risk, but also, or in the context of supplier risk and customer risk.

Similarly, there is value in recognizing and assessing an opportunity that may exist. For example, a subject entity may wish to project how much of a product it can sell to a particular one of its customers, e.g., Company A. In a traditional approach, the subject entity will consider information it can obtain about Company A itself, and make a projection based on that information. However, the quality of the assessment will likely be improved by also evaluating relationships between Customer A and its customers.

In practice, obtaining information about business relationships has not been an easy task. There has not been a systematic method to identify a business network in a scalable fashion. For example, in order to identify a supplier's supplier, or a customer's customer, an often-used approach is to conduct a survey. However, conducting and evaluating results of a survey are very manual intensive and time consuming processes that typically involve making phone calls or sending questionnaires to many businesses, and requesting information. The responses from a survey are often unreliable and are rarely ever validated by third party information.

### SUMMARY OF THE DISCLOSURE

There is a need for a system and a method that identifies and quantifies, for a first entity, a relevance of a second entity to the first entity. The relevance may be indicative of either a risk to the first entity, or an opportunity for the first entity.

To address this need, there is provided a method that includes (a) examining records that describe transactions between entities, (b) constructing, in a database, a data structure that represents a relationship network, based on the transactions, where the relationship network represents (i) a first entity and (ii) a second entity that is separated from the first entity by N tiers, and where N is a whole number greater than or equal to 1, and (c) calculating a relevance of the second entity to the first entity as a function of, i.e., based on, a characteristic of the second entity and the transaction between the first entity and the second entity, which could be frequency, volume and value of goods and services in the transaction. There is also provided a system that performs the method, and a storage medium that contains instructions for controlling a processor to perform the method.

A transaction evaluation process reads data from a database of business transactions, and creates a reference table that summarizes certain aspects of the transactions, and lists them in an organized manner. A discovery process discovers a business relationship network in a systematic and scalable manner by considering data in the reference table. The business relationship network reveals how a first entity, i.e., a first business, is related to second entity, i.e., another business, in an N-th tier of the business relationship network, and maps a unique path from the tier N entity to the first entity, where N is a whole number greater than or equal to one. A relevance assessment process assesses a risk of, or an opportunity for, the first entity by considering risks and opportunities associated with its related entities, and is therefore more comprehensive than merely evaluating the first entity as a stand-alone entity. These processes provide a decision maker, e.g., a credit manager or a purchasing manager, with visibility into the business relationship network, and can also provide alerts concerning any business within the network. The alerts could be with regard to business characteristics, its business network, socio-economic conditions, political uncertainties, climate and catastrophic changes.

### BRIEF DESCRIPTION OF THE DRAWINGS

FIG. 1 is an illustration of a 3-tier business relationship network.

FIG. 2 is an illustration of a 3-tier supply chain network.

FIG. 3 is a table that shows an example of a calculation for a Within Tier Indexes for a supplier.

FIG. 4 is a table that provides an example of a calculation of a Supply Chain Risk Index for a supplier.

FIG. 5 is a table that shows an example of a calculation for a Within Tier Indexes for a supplier.

FIG. 6 is a table that provides an example of a calculation of a Supply Chain Risk Index for a supplier.

FIG. 7 is a block diagram of a system for discovering a business relationship network and assessing a relevance of a relationship between entities.

FIG. 8 is a flowchart of a transaction evaluation process.

FIGS. 9A and 9B, together, are a flowchart of discovery process.

FIG. 10 is a state table that shows an evolution of several variables that are being affected during an exemplary execution of a discovery process.

FIGS. 11A-11J, collectively, show an evolution of a data structure.

A component or a feature that is common to more than one drawing is indicated with the same reference number in each of the drawings.

### DESCRIPTION

The present document discloses a technique for evaluating business risk or opportunity for a subject entity, based on characteristics of entities associated with the subject entity in a business relationship network. For example, if considering risk, determining factors could include the risk of each entity in the network, how critical a particular entity is to the operation of the subject entity, and the distance, i.e., degree of separation (N), of a tier N entity from the subject entity, and any other properties that describe the network. Considering the risk of each entity in the network could put an entity at a higher or lower risk than another entity, even if both are of the same risk when they are evaluated individually.

The technique has two major processes. One process is tier N business relationship network discovery, and the other process is relevance assessment with network effect.

The tier N business relationship network discovery process, hereinafter “the discovery process”, identifies entities in business relationships as buyers and sellers, and links the entities together in a network. Starting with a subject entity, the discovery process links the subject entity with an entity, i.e., a tier 1 entity, with which the subject entity does business directly, and thereafter, with an entity, i.e., a tier 2 entity, with which the tier 1 entity does business directly, and so on and so forth until a tier N business relationship is discovered, where N is a whole number greater than or equal to one. The discovery process performs a recursive mapping. Recursive mapping is a technique that repeatedly considers data in a database to find an entity in a tier, and thereafter find a related entity in a next tier, and continuing the mapping until reaching tier N. The result is a tier N business relationship network database that includes a relationship chain as a unique path from a tier N entity to the subject entity.

The relevance assessment with network effect process, hereinafter “the relevance assessment process”, evaluates a risk or opportunity for a subject entity based on characteristics of other entities in its network. For example, a process for evaluating risk for the subject entity considers (a) the risk of each entity in the network, (b) how critical another entity is to the operation of the subject entity, (c) the distance, i.e., degree of separation, of a tier N entity from the subject entity, and (d) other factors that can describe the properties of the business relationship network.

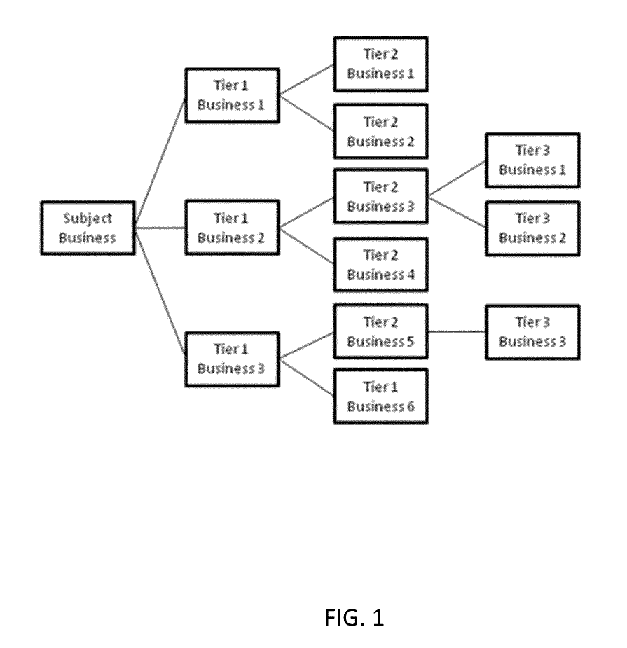

FIG. 1 is an illustration of a 3-tier business relationship network. A subject business has a connecting line to each of tier 1 business 1, tier 1 business 2 and tier 1 business 3, thus indicating that the subject business conducts business with tier 1 business 1, tier 1 business 2, and tier 1 business 3. Similarly, tier 1 business 1 conducts business with tier 2 business 1 and tier 2 business 2. Thus, FIG. 1 illustrates a business relationship network that extends for 3 tiers from the subject business. Depending on the nature of the transactions between the businesses shown in FIG. 1, the business relationship network could be a supply chain network, a customer chain network, or a hybrid of a supply chain and a customer chain.

One application of this methodology is to create a Supply Chain Risk Index (SCRI), which is further described below. A database contains records that describe transactions, e.g., customer data, supplier data, shipment data, etc. There are two entities involved in each record, one as a buyer and the other as a seller. If two records exist such that in one record entity A buys from entity B, and in another record entity B buys from entity C, an inference can be drawn that there is a supply chain relationship from entity C to entity B, and then to entity A. Similarly, if entity B is a customer of entity A, and entity C is a customer of entity B, an inference can be drawn that there is a customer chain relationship from entity C to entity B, and then to entity A.

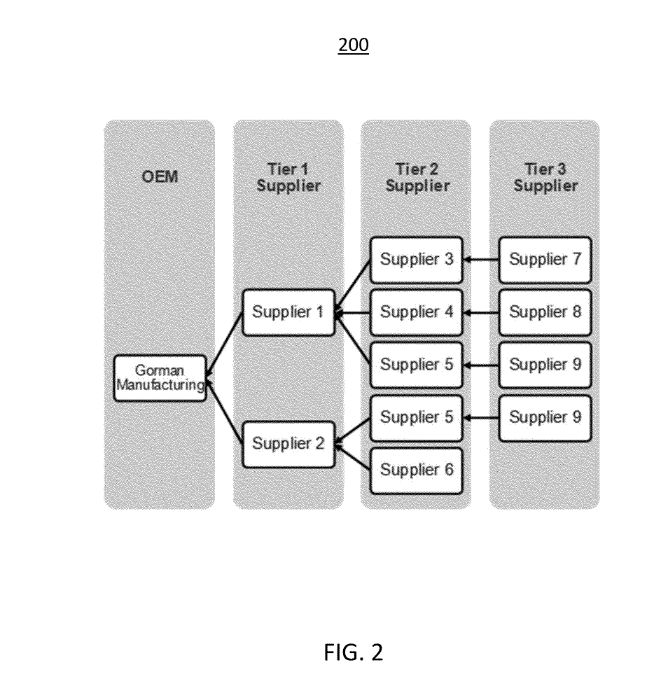

FIG. 2 is an illustration of a 3-tier supply chain network, designated as network 200, to which we are referring for an example of the relevance assessment process being utilized for an assessment of risk of a business. In network 200, Gorman Manufacturing is an original equipment manufacturer (OEM), and is referred to as a subject business. Gorman Manufacturing has two direct suppliers, namely Supplier 1 and Supplier 2.

Supplier 1 has three direct suppliers, namely Supplier 3, Supplier 4 and Supplier 5.

Supplier 2 has two direct suppliers, namely Supplier 5 and Supplier 6. Thus, Supplier 5 is a supplier to both of Supplier 1 and Supplier 2.

Supplier 3 has one direct supplier, namely Supplier 7.

Supplier 4 has one direct supplier, namely Supplier 8.

Supplier 5 has one direct Supplier, namely Supplier 9. In FIG. 2, Supplier 9 is shown twice, i.e., once for each occurrence of Supplier 5.

Suppliers 1 and 2 are referred to as Gorman Manufacturing's tier 1 suppliers. Suppliers 3, 4, 5 and 6 are referred to as Gorman Manufacturing's tier 2 suppliers. Suppliers 7, 8 and 9 are referred to as Gorman Manufacturing's tier 3 suppliers.

Each unique path from a tier N supplier to Gorman Manufacturing is defined as a supply chain. In this example, there are five unique supply chains, namely:

### (1) Supplier 7—Supplier 3—Supplier 1—Gorman Manufacturing;

### (2) Supplier 8—Supplier 4—Supplier 1—Gorman Manufacturing;

### (3) Supplier 9—Supplier 5—Supplier 1—Gorman Manufacturing;

### (4) Supplier 9—Supplier 5—Supplier 2—Gorman Manufacturing; and

### (5) Supplier 6—Supplier 2—Gorman Manufacturing.

The relevance assessment process creates an SCRI, which is a weighted index, for each tier 1 supplier, to assess the tier 1 supplier's risk exposure from itself and its network of suppliers. In network 200, an SCRI is created for Supplier 1 and Supplier 2 in tier 1, and is determined by three factors:

### (1) Supplier Evaluation Risk (SER);

(2) Criticality factor (CF); and
(3) Tier factor (TF).

SER is a score that predicts an operational risk of a business. It ranges from 1 to 9, 1 being the lowest risk and 9 being the highest risk of becoming inactive in the next 12 months. If a SER is unavailable, it can be replaced by a similar score, such as a Supplier Stability Index. In general, any type of risk score can be used.

The criticality factor is a weight, for a supplier, that indicates how critical the supplier is to a subject entity, and could be based, for example, on the importance or the total monetary value of products and materials being supplied to the buyer. Criticality could also be defined by industry classification, transaction value, or product details. A criticality factor can be either a default value or a value established by the user. Table 1 provides exemplary weights for the criticality factor.

TABLE 1

| Default Value | High | Medium | Low |
|---|---|---|---|
| Criticality factor | 1.5 | 1 | 0.5 |

The tier factor is a weight, assigned to a tier, that is indicative of a degree of separation, in terms of a number of tiers, between a supplier and a subject entity. One purpose of the tier factor is to indicate how quickly an event that originated from the supplier can impact the subject entity. The greater the separation, i.e., the greater the number of tiers, between the subject entity and the supplier, the lower will be the weight. Thus, a weight is assigned to tier 1, a lower weight is assigned to tier 2, and an even lower weight is assigned to tier 3. A tier factor can be either a default value or a value established by the user. The values of tier factor over all tiers are summed up to one. Table 2 provides exemplary weights for the tier factor.

TABLE 2

| Default Value | Tier 1 | Tier 2 | Tier 3 |
|---|---|---|---|
| Tier factor | 0.6 | 0.25 | 0.15 |

The relevance assessment process, for a case of risk assessment, takes a two-step approach to calculating the SCRI for each tier 1 supplier. The first step is to calculate a Within Tier Index for each tier in the business relationship network. The second step is to calculate SCRI across tiers for each tier 1 supplier.

Within Tier Index is a weighted average of the risk associated with all suppliers in a tier. It is affected by the number of supply chains impacted by a supplier, the industry to which the supplier belongs, and the risk level of that supplier. Mathematically,

Within Tier Index=Σₙ₌₁^{N}(SER)ₙ(Criticality Factor)ₙ/Σₙ₌₁^{N}(Criticality Factor)ₙ

where N=the number of suppliers in the tier being considered.

To calculate the Within Tier Index, for example, suppose we use industry classification to measure criticality factor. Manufacturing industry could be deemed as the most critical to the operation of Gorman Manufacturing, so a criticality factor of 1.5 is assigned. Wholesales and services industries are important but less critical, so a criticality factor of 1 is assigned. All other industries are considered less important, so a criticality factor of 0.5 is assigned. Thus:

(a) manufacturing industry criticality factor=1.5;
(b) wholesale industry criticality factor=1;
(c) services industry criticality factor=1; and
(d) all other industries criticality factor=0.5.

Additionally, assume the following:

(a) Supplier 1 has an SER=2, and is in the manufacturing industry;
(b) Supplier 2 has an SER=2, and is in the manufacturing industry;
(c) Supplier 3 has an SER=5, and is in the manufacturing industry;
(d) Supplier 4 has an SER=3, and is in the finance industry;
(e) Supplier 5 has an SER=8, and is in the wholesale industry;
(f) Supplier 6 has an SER=1, and is in the manufacturing industry;
(g) Supplier 7 has an SER=1, and is in the manufacturing industry;
(h) Supplier 8 has an SER=6, and is in the services industry; and
(i) Supplier 9 has an SER=4, and is in the telecom industry.

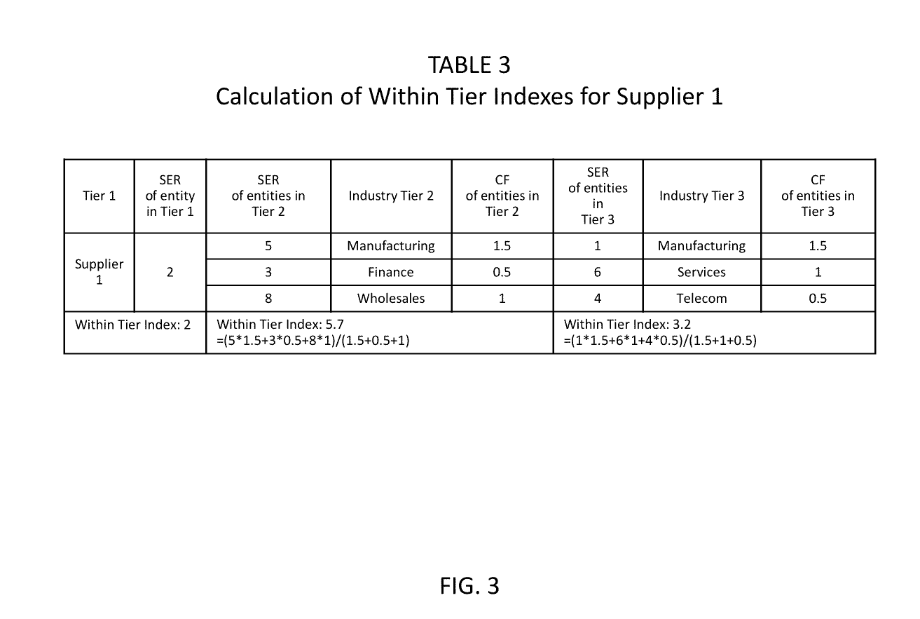

FIG. 3 is a table, i.e., Table 3, that shows calculations for the Within Tier Indexes for Supplier 1. Note that for the Within Tier Index for tier 1, there is no consideration of the criticality factor. This is because the Within Tier Index for tier 1 has only one entity, i.e., Supplier 1, and therefore the Within Tier Index for tier 1 is not a weighted average.

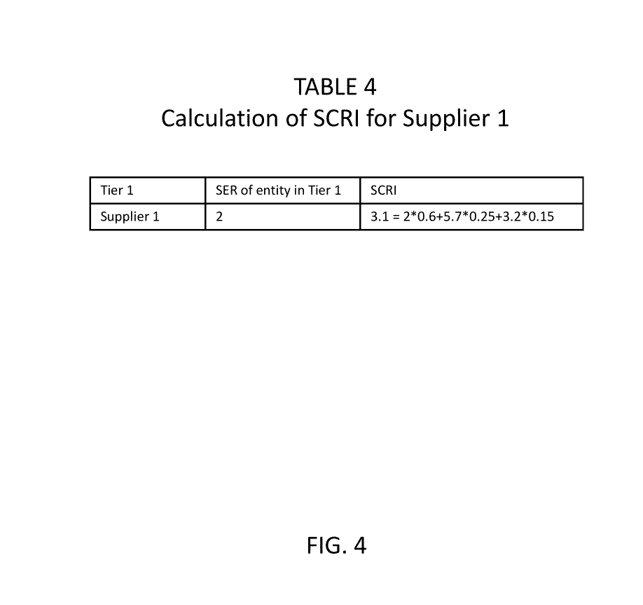

FIG. 4 is a table, i.e., Table 4, that provides an example of a calculation of SCRI for Supplier 1.

$$SCRI = {\sum }_{n = 1}^{N} {( Within Tier Index )}_{n} {( Tier Factor )}_{n}$$

where N=the number of tiers being considered.

Table 3 shows the Within Tier Indices, and Table 4 shows the Tier Factors.

For Tier 1, Within Tier Index=2, and Tier Factor=0.6.

For Tier 2, Within Tier Index=5.7, and Tier Factor=0.25.

For Tier 3, Within Tier Index=3.2, and Tier Factor=0.15.

Accordingly, as shown in Table 4:

### SCRI=(2×0.6)+(5.7×0.25)+(3.2×0.15)

### SCRI=1.2+1.425+0.48

### SCRI=3.105

SCRI=3.1 (approximately)

Thus, the SCRI for Supplier 1 is 3.1, which is a higher risk score than if the relevance assessment process was to evaluate Supplier 1 by itself (SER=2). The driving factor for the higher risk score is a risky business in tier 2 with SER being 8 (i.e., Supplier 5 has an SER=8), and the contribution of risk by Supplier 5 would not be known if the relevance assessment process did not have the view into the business relationship network, or if the relevance assessment process did not take into consideration the network effect on risk.

The relevance assessment process also considers the risk associated with other suppliers in tier 1, in this case Supplier 2.

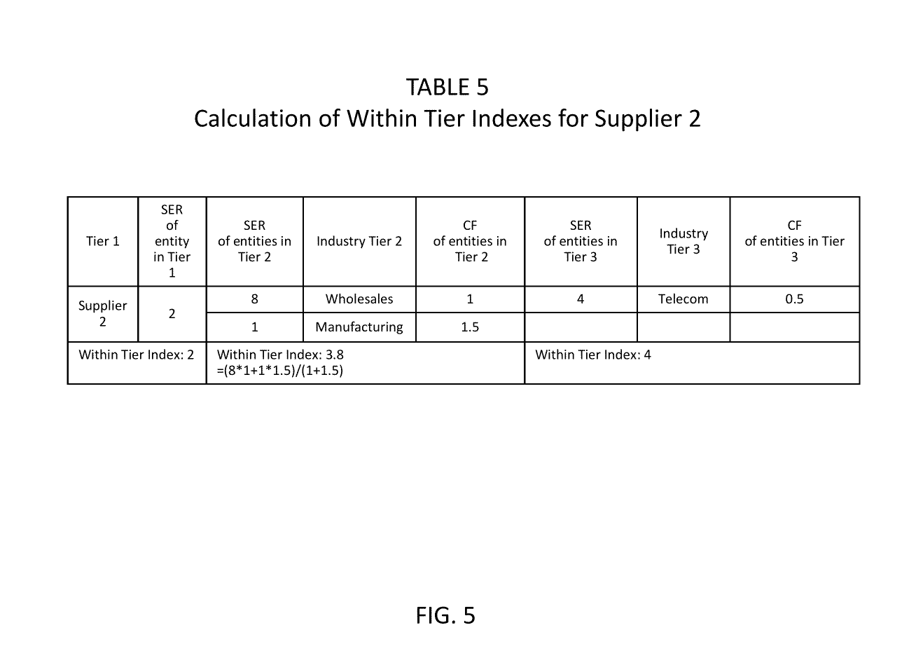

FIG. 5 is a table, i.e., Table 5, that shows calculations for the Within Tier Indexes for Supplier 2. Note that for the Within Tier Index for tier 1, there is no consideration of the criticality factor. This is because the Within Tier Index for tier 1 has only one entity, i.e., Supplier 2, and therefore the Within Tier Index for tier 1 is not a weighted average.

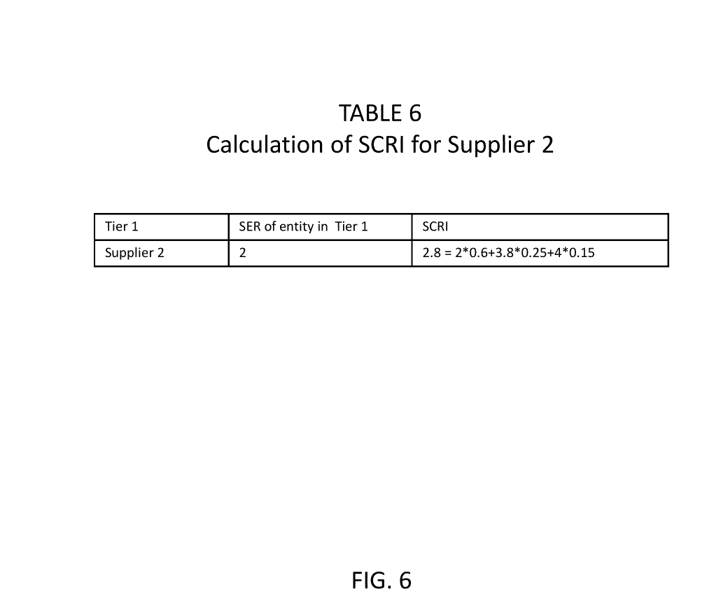

FIG. 6 is a table, i.e., Table 6, that provides an example of a calculation of SCRI for Supplier 2. Thus, the SCRI for Supplier 2=2.8.

Comparing Supplier 1 and Supplier 2, the traditional approach would be to use a supplier risk score based on each supplier itself, such as SER, to evaluate risk, and as such, the risk level of these two suppliers would be deemed to be the same (i.e., SER=2). However, SCRI provides differentiation of risk between Supplier 1 and Supplier 2, by taking into account a network effect. When considering SCRI, Supplier 1 has a higher supply chain risk (i.e., 3.1) than Supplier 2 (i.e., 2.8).

In the relevance assessment process, the weights that are used in the criticality factor and the tier factor are flexible, and should be adjusted based on business needs. For example, if a business decision maker wants to focus on risks rooted from tier 2 and further upstream, e.g., in tier 3, he or she can assign a lower tier factor to tier 1, such as 0, and higher tier factors to tier 2 and tier 3, such as 0.65 and 0.35.

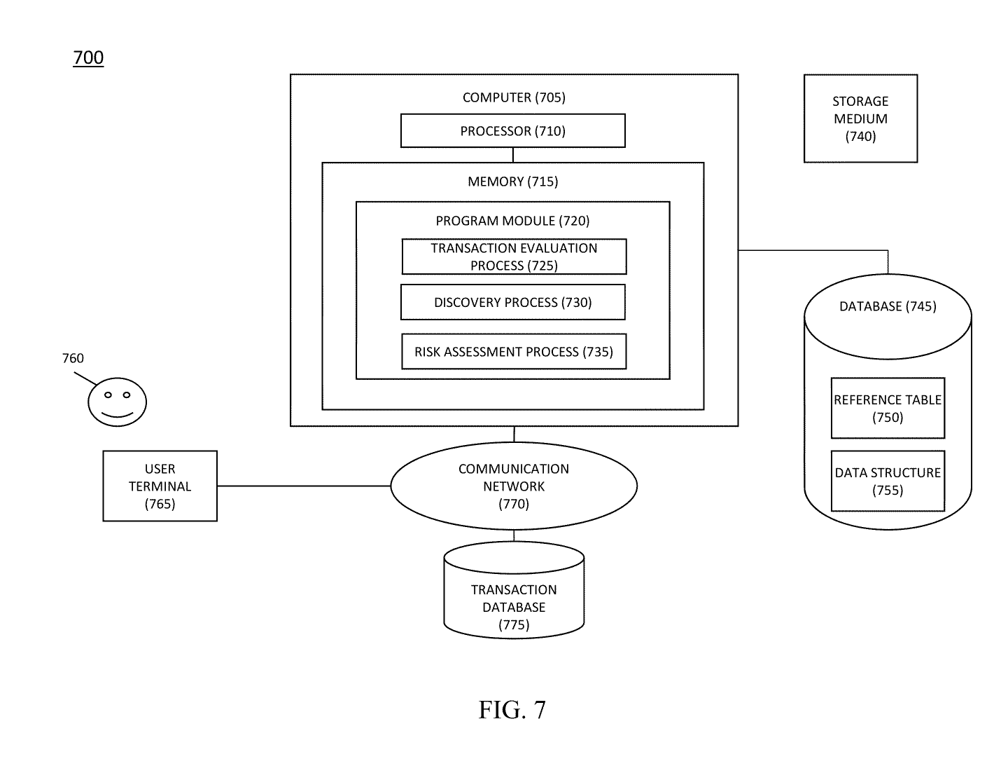

FIG. 7 is a block diagram of a system 700 for discovering a business relationship network and assessing a relevance of a relationship between entities. System 700 includes a computer 705, a user terminal 765, and a transaction database 775. Computer 705, user terminal 765, and transaction database 775 are communicatively coupled to a communication network 770, e.g., the Internet. Communications are conducted via communication network 770 by way of electronic and optical signals.

Computer 705 includes a processor 710 coupled to a memory 715. Although computer 705 is represented herein as a standalone device, it is not limited to such, but instead can be coupled to other devices (not shown) in a distributed processing system.

Processor 710 is configured of logic circuitry that responds to and executes instructions.

Memory 715 is a tangible storage medium that is readable by processor 710, and stores data and instructions for controlling the operation of processor 710. Memory 715 may be implemented in a random access memory (RAM), a hard drive, a read only memory (ROM), or a combination thereof. One of the components of memory 715 is a program module 720.

Program module 720 includes instructions for controlling processor 710 to perform the operations of the transaction evaluation process, the discovery process and the relevance assessment process, which are embodied in a transaction evaluation process 725, a discovery process 730, and a relevance assessment process 735, respectively.

The term “module” is used herein to denote a functional operation that may be embodied either as a stand-alone component or as an integrated configuration of a plurality of sub-ordinate components. Thus, program module 720 may be implemented as a single module or as a plurality of modules that operate in cooperation with one another. Moreover, although program module 720 is described herein as being installed in memory 715, and therefore being implemented in software, it could be implemented in any of hardware (e.g., electronic circuitry), firmware, software, or a combination thereof.

While program module 720 is indicated as being already loaded into memory 715, it may be configured on a storage medium 740 for subsequent loading into memory 715. Storage medium 740 can be any tangible storage medium that stores program module 720 thereon. Examples of storage medium 740 include a floppy disk, a compact disk, a magnetic tape, memory sticks, a read only memory, an optical storage media, universal serial bus (USB) flash drive, a digital versatile disc, or a zip drive. Storage medium 740 can be a random access memory, or other type of electronic storage, located on a remote storage system and coupled to computer 705 via communication network 770.

User terminal 765 is an input/output device that can receive input from a user 760 and output results to user 760. For example, user terminal 765 can include a keyboard or speech recognition subsystem, for enabling user 760 to communicate information and command selections to processor 710. User terminal 765 also includes output devices such as a display or a printer. A cursor control such as a mouse, track-ball, or joy stick, allows the user to manipulate a cursor on the display for communicating additional information and command selections to processor 710.

Through user terminal 765, user 760 sends a request to computer 705 for computer 705 to discover a business relationship network and assess a business risk for an entity. Thereafter, also through user terminal 765, user 760 receives, from computer 705, a result of the execution of discovery process 730 and relevance assessment process 735.

Transaction database 775 contains data such as customer data, supplier data, shipment data, etc. of transactions between buyers and sellers. Each record in transaction database 775 typically includes one buyer and one seller, and may include additional data such as the date, volume, product description, and value of the transaction. Although transaction database 775 is illustrated as a single storage device, it could be implemented as a plurality of storage devices that are located remotely from one another. Additionally, although transaction database 775 and computer 705 are shown as being coupled to one another via communication network 770, they could be coupled via a local network (not shown), or directly connected to one another.

System 700 also includes a database 745 that is communicatively coupled to computer 705. Database 745 is a storage device, e.g., a computer memory, that contains a reference table 750 and a data structure 755. Reference table 750 is produced by processor 710 as a result of the execution of transaction evaluation process 725. Data structure 755 is created by processor 710 as a result of the execution of discovery process 730. Although database 745 is shown in FIG. 7 as being implemented on a single storage device and being directly connected to computer 705, it may be implemented over a plurality of storage devices that are located remotely from computer 705, and coupled to computer 705 by way of communication network 770.

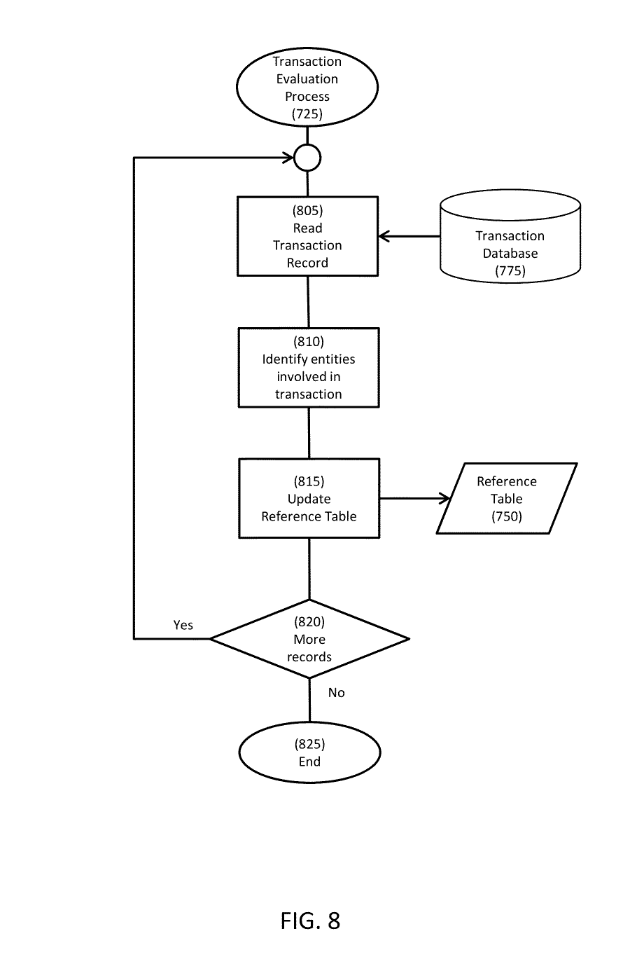

FIG. 8 is a flowchart of transaction evaluation process 725, which commences with step 805.

In step 805, processor 710 reads a transaction record from transaction database 775. The transaction record concerns a transaction between two entities, e.g., a buyer and a seller.

In step 810, processor 710 identifies the entities involved in the transaction. In a preferred embodiment, each entity is matched to a Data Universal Numbering System (DUNS) number, which can thereafter be used to identify the entity.

In step 815, processor 710 adds to reference table 750, data concerning the transaction. As explained below, reference table 750 will be used during an execution of discovery process 730 to produce data structure 755.

In step 820, processor 710 determines whether there are more records in transaction database 775 to be processed. If YES, transaction evaluation process 725 loops back to step 805. If NO, transaction evaluation process 725 progresses to step 825.

In step 825, transaction evaluation process 725 ends.

Table 7. below, is an exemplary representation of reference table 750. In Table 7, S1-S9 are shorthand representations for Suppliers 1-9, respectively. For example, Row 1 represents a transaction between Supplier 1 and Supplier 3, where Supplier 1 is a buyer, and Supplier 3 is a seller.

TABLE 7

| Row | Buyer | Seller |
|---|---|---|
| 1 | S1 | S3 |
| 2 | S1 | S4 |
| 3 | S1 | S5 |
| 4 | S2 | S5 |
| 5 | S2 | S6 |
| 6 | S3 | S7 |
| 7 | S4 | S8 |
| 8 | S5 | S9 |

In practice, reference table 750 will be substantially larger than shown in Table 7. It may contain millions of entries, representing millions of transactions. It may also contain other information relating to the transactions.

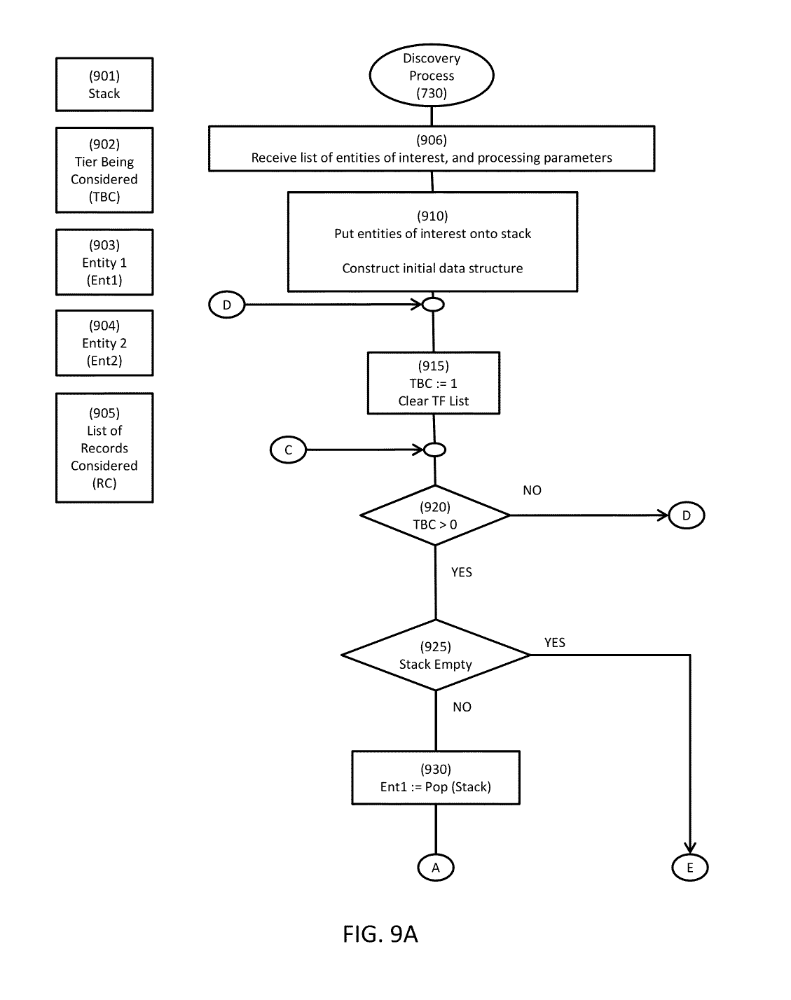

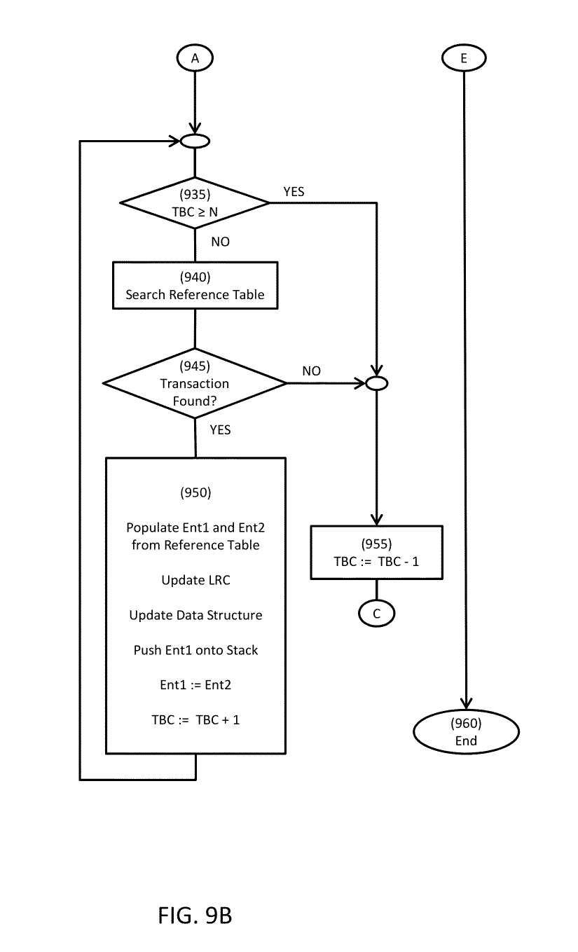

FIGS. 9A and 9B, together, are a flowchart of discovery process 730. The operations of discovery process 730 are described herein by way of an example in which user 760 works for Gorman Manufacturing and wishes to learn of the supply chain risks associated with each of Supplier 1 and Supplier 2. The example will use data for reference table 750 as shown in Table 7, above, and will construct data structure 755 to represent network 200, i.e., a supply chain. In the example, and as indicated above in the description of Table 7, S1-S9 are shorthand representations for Suppliers 1-9, respectively.

Discovery process 730 uses several variables and data structures, namely a stack 901, tier being considered (TBC) 902, Entity 1 (Ent1) 903, Entity 2 (Ent2) 904, and a list of records considered (LRC) 905.

Stack 901 is a data structure that facilitates a recursive mapping feature of discovery process 730.

TBC 902 is a variable that indicates the tier being considered.

Ent1 903 is a variable that holds an identifier of an entity for which a relationship is being sought, and Ent2 904 is a variable that holds an identifier of an entity that was most recently discovered. For example, if we know S1, and we are looking for a supplier of S1, then Ent1 903 will hold the identifier S1, and when we find a supplier of S1, Ent2 904 will take on the identifier of that newly found supplier.

LRC 905 is a list of records of reference table 750 that have been considered during discovery process 730.

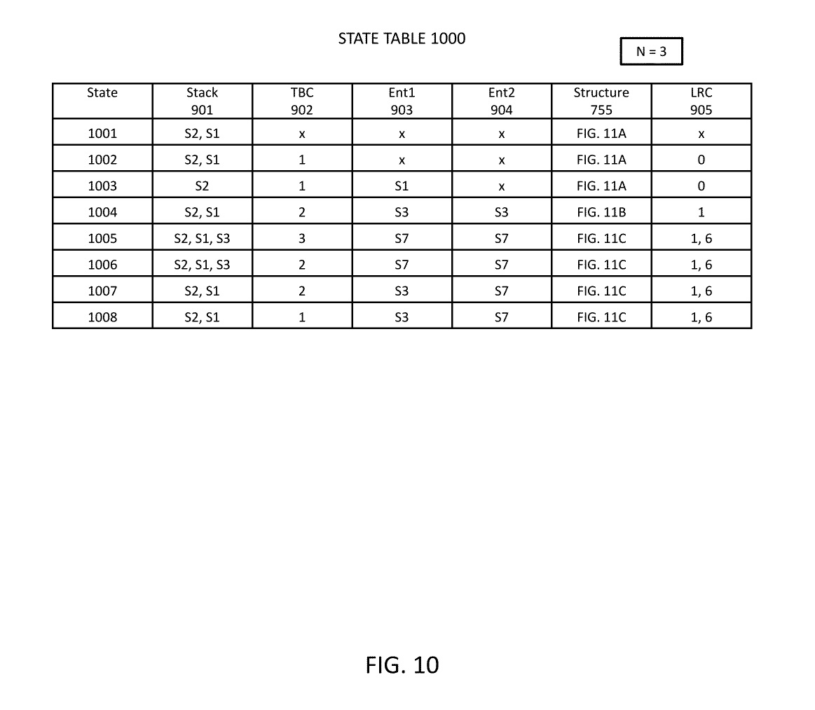

FIG. 10 is a state table 1000 that shows an evolution of several variables that are being affected during the exemplary execution of discovery process 730. State table 1000 is organized in rows that are identified by state numbers beginning with state 1001, and columns having headings that indicate:

(a) Stack 901 content of stack 901;
(b) TBC 902 value of TBC 902;
(c) Ent1 903 content of Ent1 903;
(d) Ent2 904 content of Ent2 904;
(e) Structure state of data structure 755; and
(f) LRC content of LRC 905.

In state table 1000, x=don't care, i.e., the content or value is irrelevant.

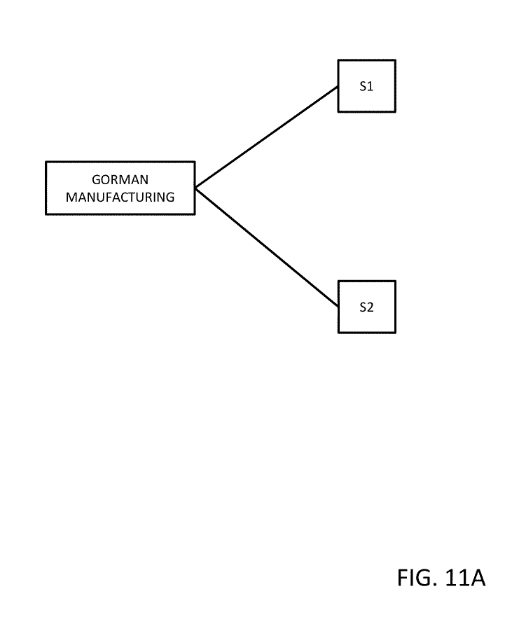

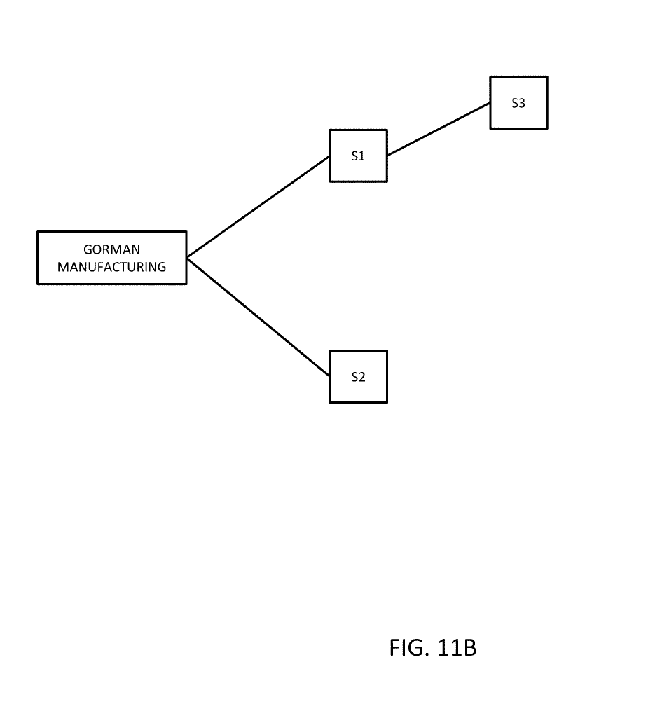

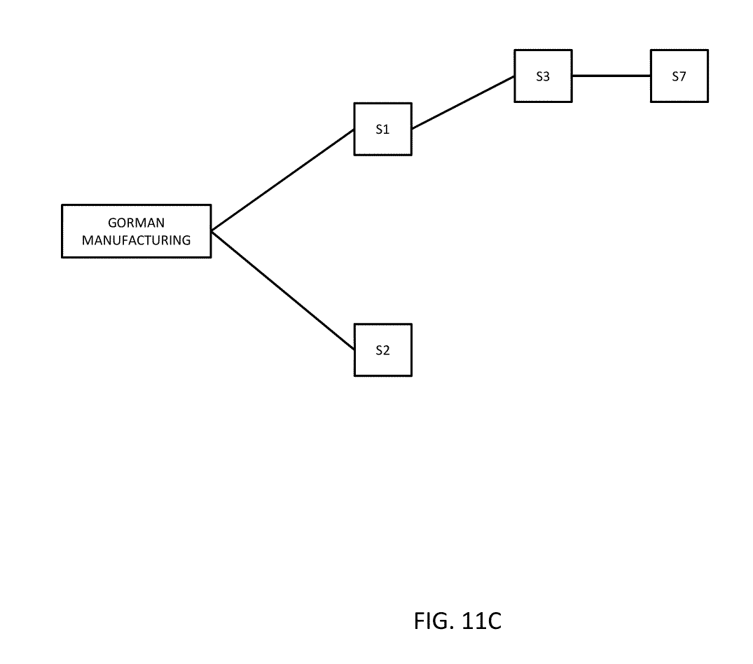

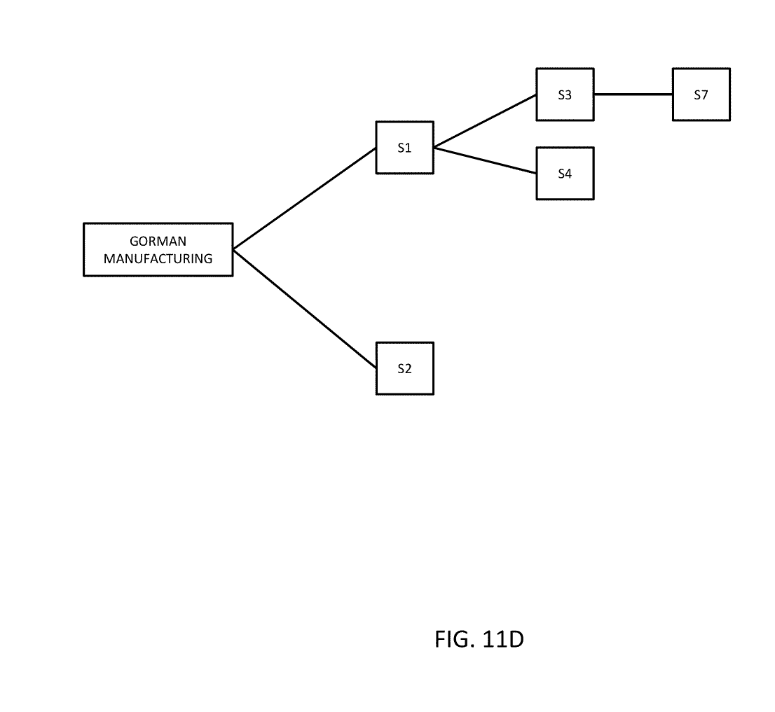

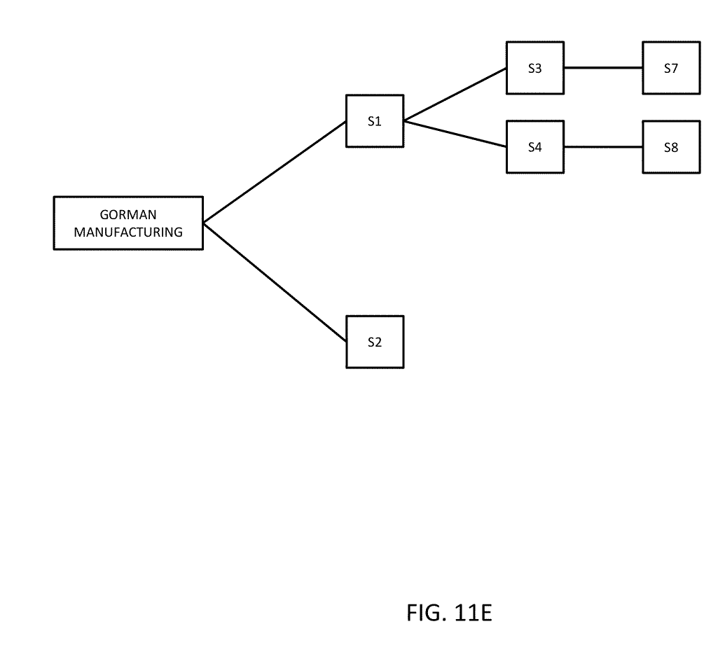

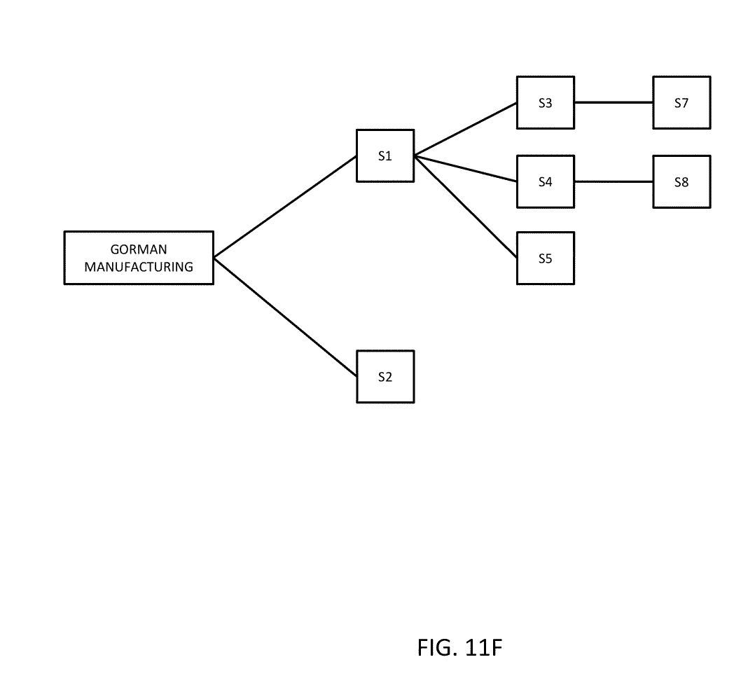

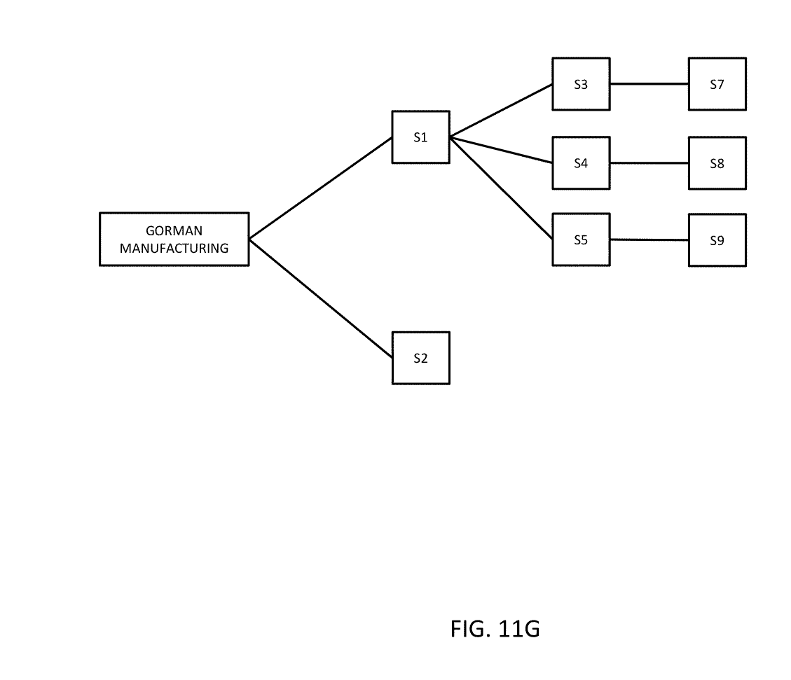

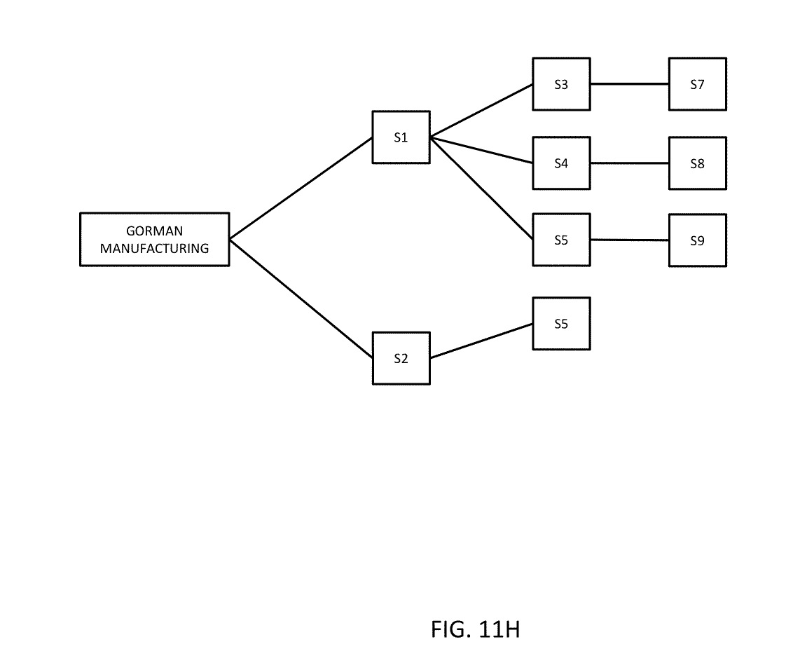

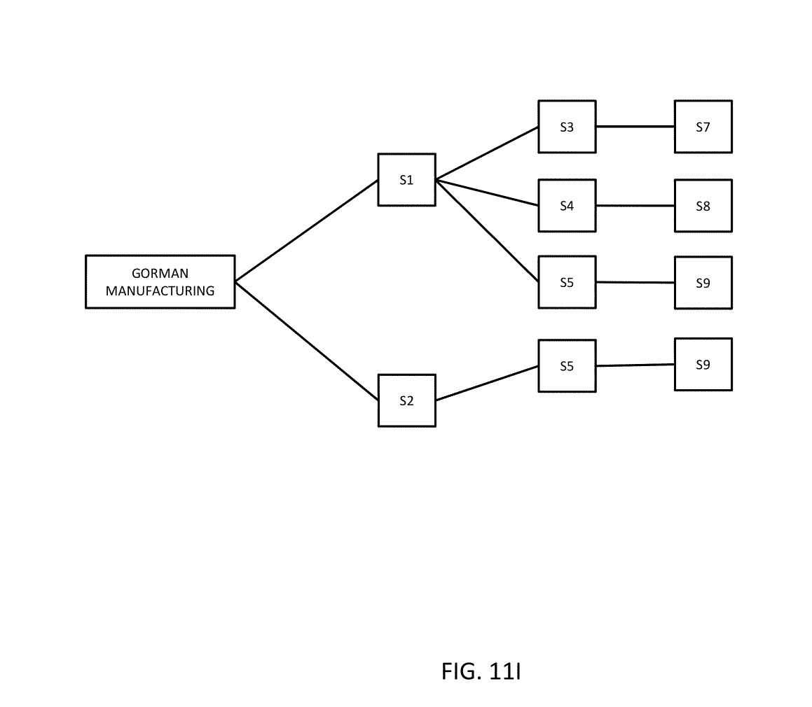

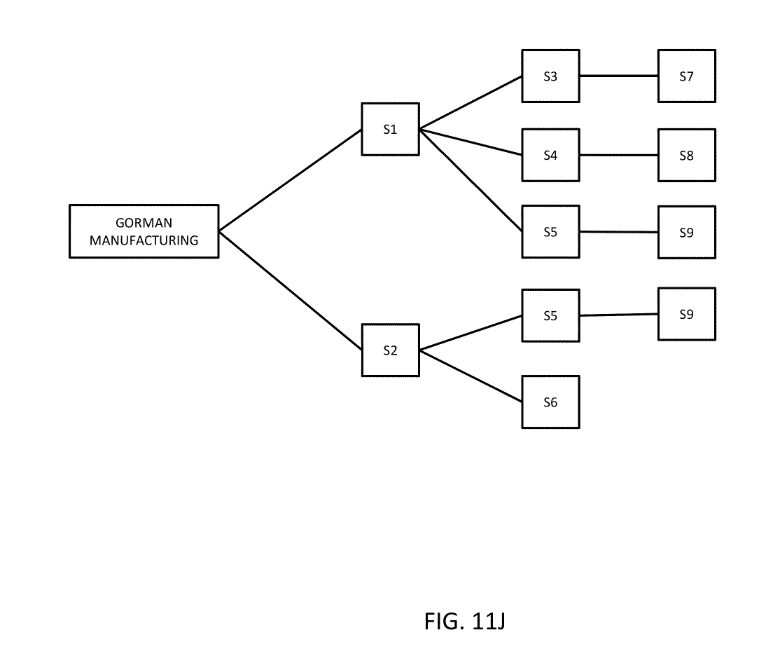

FIGS. 11A-11J, collectively, show an evolution of data structure 755.

In the description of discovery process 730, below, to assist in readability, the present document includes headings, such as “INITIALIZATION” and “DISCOVER S1-S3”, that generally describe activities that are taking place.

Initialization

Discovery process 730 commences with step 906.

In step 906, by way of user terminal 765, user 760 sends, and processor 710 receives, a communication requesting a risk analysis of Supplier 1 and Supplier 2. In the communication, user 760 also includes processing parameters such as (a) the type of risk score to employ, e.g., SER or some other score, (b) the critical factors for various industries, (c) the tier factors, and (d) the number of tiers (N) to be included in the analysis. From step 906, discovery process 730 progresses to step 910.

Assume that N=3. As a reminder, and to facilitate the presentation of the present example, in FIG. 10, in the top right, there is a box showing N=3.

In step 910, processor 710 (a) clears stack 901, and thereafter puts the entities of interest, i.e., S1 and S2, onto stack 901, and (b) commences construction of data structure 755. See state 1001 and FIG. 11A. In state table 1000, in the column that shows the status of stack 901, the rightmost value is the top of stack 901. So, for example, in state 1001, S1 is on the top of stack 901. From step 910, discovery process 730 progresses to step 915.

In the present document, the operator “:=” means that a first operator takes on a value designated by a second operator. For example, A:=B means that A takes on the value of B. Similarly, A:=1 means that A takes on the value 1.

In step 915, processor 710 sets TBC:=1, and clears LRC 905. See State 1002. From step 915, discovery process 730 progresses to step 920.

Discover S1-S3

In step 920, processor 710 considers whether TBC is greater than zero. When considering relationships at various tiers, the number of the tier being considered should always be greater than zero. If TBC is greater than zero, discovery process 730 progresses to step 925. If TBC is not greater than zero, discovery process 730 loops back to step 915.

In step 925, processor 710 considers whether stack 901 is empty. If stack 901 is not empty, discovery process 730 progresses to step 930. If stack 901 is empty, it means that all discoverable transactions have been processed, and accordingly, discovery process 730 advances to step 960.

In step 930, processor 710 pops the top entry from stack 901, and assigns it to Ent1 901. In the present example, S1 is popped from stack 901, and so, Ent1 903 takes on the value S1. See state 1003. This means that processor 710 will search for an entity with which S1 has conducted a transaction. From step 930, discovery process 730 progresses to step 935.

In step 935, processor 710 tests whether TBC is greater than or equal to N. This test ensures that discovery process 730 examines relationships only in tiers numbered less than or equal to N. If TBC is not greater than or equal to N, discovery process 730 will progress to step 940. If TBC is greater than or equal to N, discovery process 730 will advance to step 955.

In the present example, as shown in state 1003, TBC=1, and in the present example N is equal to 3. TBC is not greater than N, and therefore, discovery process 730 progresses to step 940.

In step 940, processor 710 searches reference table 750 for a transaction in which Ent1 903 is a party. In the present example, since we are constructing a supply chain, Ent1 903 is regarded as a buyer. Turning to Table 7, above, Row 1 presents a transaction in which S1 is a buyer. From step 940, discovery process 730 progresses to step 945.

In step 945, processor 710 considers whether a transaction was found in step 935. If a transaction was found, discovery process 730 progresses to step 950. If a transaction was not found, discovery process 730 advances to step 955.

In step 950, processor 710 populates Ent1 903 and Ent2 904 from the transaction found in step 940. Accordingly, reading from Table 7, Row 1, processor 710 assigns:

### Ent1 903:=S1; and

### Ent2 904:=S3.

Thereafter, and also in step 950, processor 710:

(a) updates LRC 905.
(b) updates data structure 755;
(c) pushes Ent1 903 onto stack 901;
(d) copies the content of Ent2 904 into Ent1 903; and
(e) increments TBC.

The result of the operations in step 950 is represented by state 1004 and FIG. 11B. For the update of LRC 905, processor 710 adds the record of reference table 750 that was just considered. In the present example, the record that was just considered is shown in Table 7, Row 1. Accordingly, in state table 1000, state 1004 shows that LRC 905 now includes the number “1”, which represents the record of Table 7, Row 1. As shown in FIG. 11B, data structure 755 now includes a link from S1 to S3. Thus, data structure 755 is a linked list of nodes that represent S1 and S3.

From step 950, discovery process 730 loops back to step 935.

Discover S3-S7

Since in step 950, Ent1 903 took the value from Ent2 904, Ent1 903 now has the value of the entity that was most recently discovered, i.e., S3. Accordingly, processor 710 will search for a link from S3 to a supplier of S3.

In the present example, processor 710 will repeat the operations of steps 935, 940, 945 and 950. In step 940, processor 710 will search reference table 750 and find a record as shown in Table 7, Row 6. Upon completion of step 950, the state of system 700 will be as indicated by state 1005, and data structure 755 will be as shown in FIG. 11C.

Processing Tier N

After the discovery of S3-S7, upon completion of step 950, discovery process 730 will loop back to step 935. However, as indicated in state 1005, TBC now equals 3. That is, TBC is greater than or equal to N. Accordingly, from step 935, discovery process 730 will advance to step 955.

In step 955, processor 710 decrements TBC. See state 1006. From step 955, discovery process 730 loops back to step 920.

In the present case, processor 710 most recently discovered S3-S7. Since S7 is in tier 3, which, in the present example, is the maximum tier number that will be searched, discovery process 730 will need to revert to a lower order tier, in this case tier 2.

Search for Another Supplier of S3

In step 920, processor 710 tests and finds TBC equal to 2, as shown in state 1006. Thus, TBC is greater than or equal to zero, and so, discovery process 730 progresses from step 920 to step 925.

In step 925, processor 710 will find that stack 901 is not empty, and so, discovery process 730 will progress to step 930.

In step 930, processor 710 pops the top entry from stack 901, and assigns it to Ent1 901. In the present example, S3 is popped from stack 901, and so, Ent1 903 takes on the value S3. See state 1007. From step 930, discovery process 730 progresses to step 935.

In step 935, processor 710 tests whether TBC is greater than or equal to N. In state 1007, TCB is equal to 2. Accordingly, discovery process 730 progresses to step 940.

In step 940, processor 710 searches reference table 750 for a transaction in which Ent1 903 is a party. However, there is a further constraint that such a transaction not be a transaction that has already been considered. Here, as shown in state 1007, Ent1 903 is identifying S3, and Table 7, Row 6, is the only transaction for which S3 is a buyer. In state 1007, LRC 905 indicates that Table 7, Row 6 has already been considered. Therefore, in step 940, processor 710 does not find a transaction. From step 940, discovery process 730 progresses to step 945.

In step 945, processor 710 considers whether a transaction was found in step 940. In the present example, the answer is NO, and so, from step 945, discovery process 730 advances to step 955.

In step 955, processor 710 decrements TBC. See state 1008. From step 955, discovery process 730 loops back to step 920.

At this point, processor 710 has discovered all of the suppliers of S3, which in the present example, is only S7. The search for suppliers of S3 is exhausted, and so, discovery process 730 must proceed by reconsidering the entity of which S3 is a supplier, i.e., 51.

Continuing Discovery

Discovery process 730 will continue its search for suppliers of S1 in tiers 2 and 3. Accordingly, data structure 755 will evolve as illustrated in FIGS. 11D-11G.

After exhausting the search of suppliers of S1, discovery process 730 will then discover a supply chain for S2. Accordingly, data structure 755 will evolve as illustrated in FIGS. 11H-11 J. Data structure 755 is a linked list of nodes that represent the entities, i.e., Gorman Manufacturing and Suppliers 1-9, in network 200.

End of Discovery

In step 960, discovery process 730 ends.

After completion of discovery process 730, processor 710 will execute relevance assessment process 735. The operations of relevance assessment process 735 are those that were described above, with reference to FIGS. 3-6. Thus, relevance assessment process 735 will produce an SCRI for each of Supplier 1 and Supplier 2.

After the calculation of the SCRIs for Supplier 1 and Supplier 2, processor 710 reports to user 760, the results of relevance assessment process 735.

Recall from Table 4, that Supplier 1 SCRI=3.1, and recall from Table 6, that Supplier 2 SCRI=2.8. Assuming that a higher SCRI is indicative of a higher risk, it would be riskier for Gorman Manufacturing to rely on Supplier 1 than to rely on Supplier 2.

To review, computer 705, and more particularly processor 701, performs a method, in accordance with instructions in program module 720, that includes:
obtaining a record that identifies a first entity, e.g., Supplier 1, and a second entity, e.g., Supplier 3, that engaged in a transaction with one another;
obtaining a record that identifies a third entity, e.g., Supplier 7, that engaged in a transaction with the second entity;
constructing in a storage device, e.g., database 745, a data structure, e.g., data structure 755, that defines a path between the first entity and the third entity via the second entity; and
calculating a risk associated with the first entity, e.g., SCRI for Supplier 1, as a function of, i.e., based on, a characteristic of the third entity.
   Additionally, the method further includes:
obtaining a record that identifies a fourth entity, e.g., Supplier 4, that engaged in a transaction with the first entity;
obtaining a record that identifies a fifth entity, e.g., Supplier 8, that engaged in a transaction with the fourth entity; and
adding to the data structure, a path between the first entity and the fifth entity via the fourth entity,
wherein the calculating the risk further includes calculating a risk associated with the first entity as a function of, i.e., based on, a characteristic of the fifth entity.

Another aspect of the method includes:
examining records that describe transactions between entities;
constructing, in a database, e.g., database 745, a data structure, e.g., data structure 755, that represents a relationship network, based on the transactions, wherein the relationship network represents (i) a first entity, e.g., Supplier 1, and (ii) a second entity, e.g., Supplier 7, that is separated from the first entity by N tiers, where N is a whole number greater than or equal to 1; and
calculating a risk associated with the first entity as a function of, i.e., based on, a characteristic of the second entity.
Additionally, the data structure provides a path, from the second entity to the first entity, via one or more intermediary entities, e.g., Supplier 3, and calculating the risk associated with the first entity is also a function of risks associated with the one or more intermediary entities.

Although system 700 is described herein as producing and assessing a supply chain network, it could just as readily be employed to produce and assess a customer chain network. For example, referring to FIG. 1, in a customer chain network, tier 1 business 1 would be a customer of the subject business, and tier 2 business 1 would be a customer of tier 1 business 1. The mechanics of discovering and assessing the risk in a customer chain network are analogous to those of the supply chain network.

In the case of assessing opportunities, system 700 will evaluate business characteristics associated with demand. For example, business size and future trend, whether it is growing or declining, are good indicators of demand in general. Past purchase behavior including the type and volume of goods and services, dollar amount, transaction frequency reveal the opportunities within a specific product group, which can also help predict what the next product purchase will be. Knowing the business demand from the customer's customers will provide a holistic view and an early sign of opportunities.

Additionally, system 700 could be employed to produce and assess a business relationship network that is a hybrid of suppliers and customers. For example, turning again to FIG. 1, in an exemplary hybrid network, tier 1 business 1 could be a supplier of the subject business, and tier 2 business 1 could be a customer of tier 1 business 1.

System 700 can recursively discover a business relation network, based on bilateral relation data. It provides an automated, consistent, objective and repeated process to identify such a network and monitor risk in totality. It improves accuracy and efficiency, and is very cost effective, compared to survey and web surfing methods of the prior art.

System 700 helps business decision makers to manage customer relation and risk in totally, no matter whether one is looking for marketing opportunities, or managing customer risks and suppliers risk. It can also be used to identify tier N suppliers in a certain country or region, which are unknown without a supplier network. For example, in 2012, the U.S Congress enacted the Dodd Frank Wall Street Reform and Consumer Protection Act to improve supply chain transparency, including sourcing from the Democratic Republic of Congo (DRD) and neighboring countries. System 700 can identify suppliers that are potentially involved with Conflict Minerals. Business network discovery process helps businesses meet regulatory requirements by improving supply chain visibility.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

What is claimed is:

1. A method comprising:
examining records that describe transactions between entities;
constructing, in a database, a data structure that represents a relationship network, based on said transactions, wherein said relationship network represents (i) a first entity and (ii) a second entity that is separated from said first entity by N tiers, where N is a whole number greater than or equal to 1; and
calculating a relevance of said second entity to said first entity as a function of a characteristic of said second entity.

2. The method of claim 1, wherein said relevance is indicative of a feature selected from the group consisting of (a) a risk to said first entity, and (b) an opportunity for said first entity.

3. The method of claim 1,
wherein said data structure provides a path, from said second entity to said first entity, via one or more intermediary entities, and
wherein said calculating said relevance is also a function of a relevance of said one or more intermediary entities to said first entity.

4. The method of claim 1, further comprising:
weighting said characteristic with a value that indicates that said second entity is N tiers from said first entity in said data structure.

5. The method of claim 1, further comprising:
weighting said characteristic with a value that indicates a criticality for said second entity selected from the group consisting of industry classification, transaction value, and product details.

6. The method of claim 1, wherein said relationship network comprises a supply chain from said second entity to said first entity.

7. The method of claim 1, wherein said relationship network comprises a customer chain from said second entity to said first entity.

8. A system comprising:
a processor; and
a memory that contains instructions that are readable by said processor to cause said processor to:
examine records that describe transactions between entities;
construct, in a database, a data structure that represents a relationship network, based on said transactions, wherein said relationship network represents (i) a first entity and (ii) a second entity that is separated from said first entity by N tiers, where N is a whole number greater than or equal to 1; and
calculate a relevance of said second entity to said first entity as a function of a characteristic of said second entity.

9. The system of claim 8, wherein said relevance is indicative of a feature selected from the group consisting of (a) a risk to said first entity, and (b) an opportunity for said first entity.

10. The system of claim 8,
wherein said data structure provides a path, from said second entity to said first entity, via one or more intermediary entities, and
wherein said calculating said risk associated with said first entity is also a function of risks associated with said one or more intermediary entities.

11. The system of claim 8, wherein said instructions also cause said processor to:
weight said characteristic with a value that indicates that said second entity is N tiers from said first entity in said data structure.

12. The system of claim 8, wherein said instructions also cause said processor to:
weight said characteristic with a value that indicates criticality for said second entity.

13. The system of claim 8, wherein said relationship network comprises a supply chain from said second entity to said first entity.

14. The system of claim 8, wherein said relationship network comprises a customer chain from said second entity to said first entity.

15. A tangible storage medium, comprising:
instructions that are readable by a processor to cause said processor to:
examine records that describe transactions between entities;
construct, in a database, a data structure that represents a relationship network, based on said transactions, wherein said relationship network represents (i) a first entity and (ii) a second entity that is separated from said first entity by N tiers, where N is a whole number greater than or equal to 1; and
calculate a relevance of said second entity to said first entity as a function of a characteristic of said second entity.

16. The tangible storage medium of claim 15, wherein said relevance is indicative of a feature selected from the group consisting of (a) a risk to said first entity, and (b) an opportunity for said first entity.

17. The tangible storage medium of claim 15,
wherein said data structure provides a path, from said second entity to said first entity, via one or more intermediary entities, and
wherein said calculating said relevance is also a function of a relevance associated with said one or more intermediary entities.

18. The tangible storage medium of claim 15, wherein said instructions also cause said processor to:
weight said characteristic with a value that indicates that said second entity is N tiers from said first entity in said data structure.

19. The tangible storage medium of claim 15, wherein said instructions also cause said processor to:
weight said characteristic with a value that indicates criticality for said second entity.

20. The tangible storage medium of claim 15, wherein said relationship network comprises a supply chain from said second entity to said first entity.

21. The tangible storage medium of claim 15, wherein said relationship network comprises a customer chain from said second entity to said first entity.
